(19) United States
(12) Patent Application Publication
(10) Pub. No.: US 2002/0116227 A1
(43) Pub. Date: Aug. 22, 2002

(54) Method and apparatus for requesting, retrieving, and obtaining de-identified medical informatiion

(76) Inventor: Richard S. Dick, Alpine, UT (US)

Correspondence Address: KIRTON & McCONKIE, Suite 1800, 60 East South Temple, Salt Lake City, UT, 84111, US

(21) Appl. No.: 10/056,236

(22) Filed: Jan. 23, 2002

Related U.S. Application Data
(63) Continuation-in-part of application No. 09/794,983, filed on Feb. 27, 2001.
Application No. 09/794,983 is a continuation-in-part of application No. 09/596,810, filed on Jun. 19, 2000.

(51) Int. Cl. G06F 17/60

(52) U.S. Cl. 705/3

(57) ABSTRACT

A method for searching for medical information executed by one or more computers comprising the steps of formulating a request for medical information concerning an individual or group of individuals, transmitting a record request to a record facilitator, the record facilitator determining which patient record sources to investigate, a record query being sent from the facilitator to the patient record sources which are appropriate, receiving a patient record report back from the patient record sources, normalizing and augmenting the patient record report before forwarding it back to the requester, and de-identifying the patient record to remove any identifying information.

### RELATED APPLICATIONS

This continuation-in-part application claims priority to U.S. patent application Ser. No. 09/794,983 filed Feb. 27, 2001, entitled Method and Apparatus for Requesting, Retrieving, and Normalizing Medical Information, which is a continuation-in-part of U.S. patent application Ser. No. 09/596,810 filed Jun. 19, 2000, entitled Method and Apparatus for Requesting and Retrieving Medical Information.

### FIELD OF THE INVENTION

This invention relates generally to the electronic access of medical information and more specifically to remote electronic access to attending physician statements, clinical information, and information regarding physicians.

### BACKGROUND OF THE INVENTION

Common Uses for Medical Information

Common uses for medical information include physician reference and diagnosis, medical research, medical training, insurance policy underwriting and claims adjusting. Many fields of insurance (e.g., life, health, disability income, long term care, casualty, and reinsurance) routinely require medical information for analysis. Such analyses of medical information typically include reviewing attending physician's statements (“APS”) and other medical records. An APS is usually considered to be the most reliable record as it contains analyses and conclusions by a licensed medical professional. Medical records may be used to help determine the risk presented by an insurance applicant. Medical records can also help determine causation and other issues relevant to claims adjusting.

Difficulties Caused by the Status of Medical Information

It may take several weeks to receive a medical record after it is requested from a medical information repository such as a physician's office or other healthcare facilities. The delay is due to the paper-only format of the records and the low priority assigned to such requests by medical providers. Since APSs and other medical records are generally restricted to paper, personnel time is required to locate, copy, and fax or mail copies to a requester; consequently requesters are charged an administrative fee for this service. The lengthy delay causes a multitude of problems for requesters. For example, a delay in obtaining medical records for use in underwriting insurance policies may cause applicants to lose interest, with a consequent loss of business to the insurer.

In an effort to shorten delays, some requesters utilize agents to travel to and manually retrieve medical records from medical providers. Although this may partially resolve the delay problem at significant expense, it does not address the problem of not knowing whether the retrieved record is complete, whether other records exist, or where more complete or other records may be located. This is a persistent problem with physician-based records and clinical records. Further, even when the existence and location of a record are known, its relevance remains uncertain until retrieved and reviewed. Because of the significant cost of manual retrieval, this is a substantial problem.

Just as insurance companies lack access to the medical records they need, healthcare providers and emergency medical technicians also have a need for access to medical records regarding patients which presently goes unmet. Healthcare providers and emergency medical technicians are sometimes required to make decisions regarding how to care for a patient under circumstances in which paper records such as physician-based records are not available. The lack of rapid access to records increases the risk of improper treatment for the patient and increases the likelihood of malpractice by the healthcare providers and emergency medical technicians.

For example, an on-call physician may need medical records for patients of other physicians within the same healthcare facility. Because of privacy concerns, the information may not always be transmittable by facsimile machine or the office may be closed. It may also difficult for the on-call doctor to send information to a healthcare facility, such as, sending prescriptions to a hospital or a pharmacy.

Some modem offices have digitized old paper records. These so-called “electronic medical records” (EMR) are scanned versions of the paper-based patient records. While providing the advantages of reduced storage space and ease of transmittal, the system does not allow computer searching and the data is still presented as it was on the paper format from which the digital record was derived. Since some manual searching is still required and there is still the same opportunity for under inclusivity of records, this improvement provides limited cost savings.

In an effort to overcome the disadvantages of electronic medical records, computer-based patient records (CPR) systems have been developed. These systems typically provide a template into which patient information and physician information is entered. These systems provide the benefits of searchability and ease of tracking. Inclusiveness of all patient records is also greatly improved. Once searched, the records can be compressed and/or encrypted and sent over the Internet. This greatly reduces the amount of staff time needed to locate and transmit the records. Instead, the physician need only review the signed authorization release form from the patient and click to release the records to a requestor.

The present invention is directed to overcoming, or at least mitigating, one or more of the problems set forth above.

### SUMMARY OF THE INVENTION

The present invention entails methods and apparatus for obtaining electronic access to patient medical records. The system works most efficiently when a healthcare facility is utilizing a computer information system (CIS) for creating, managing and/or storing computerized patient records or electronic medical records, but the system can work advantageously with virtually any type of digitized medical record. The preferred embodiment of the system and method comprise a request facilitator which receives requests for medical records from a requestor such as an insurance company, physician, etc. and forwards the request through a CIS vendor or service provider to the appropriate healthcare facility or physician. As used herein, the term “healthcare facility” refers to any office, building or location, physical or electronic, where healthcare related services are rendered, including but not limited to clinics, hospitals, pharmacies, laboratories, healthcare providers and other medical information repositories.

The CIS vendor or service provider sends a prompt to the healthcare provider to inquire as to whether the records can be released. For purposes of this application, a healthcare provider can be any person or organization that renders healthcare related services, including but not limited to clinics hospitals, pharmacies and labs. Having received the request to release the records and after having verified authorization to do so, the healthcare provider manually or automatically releases the records, forwarding them to the facilitator. The records are then forwarded to the requester.

The method may also include the steps of searching the medical information repository for information regarding a patient or healthcare provider. More complex methods also include payment schemes for remuneration of healthcare facilities or CIS providers. The step of transmitting may also include transmission to a request facilitator facility for normalization to a preselected format or other processing prior to responding to the requestor.

Some benefits of the present invention include a reduction in response time to requests, information in a preselected format for ease of analysis and when encryption systems are utilized, better security than faxing the information.

Further, a healthcare facility is not overburdened by requests for information because computers handle the requests. Since access is electronic, information requesters do not have to incur traditional fees for agents to travel and retrieve the information.

The retrieved information is more inclusive since a computer can search for every instance of an identifier in an entire healthcare facility or several healthcare facilities' records. Other information such as physician or DEA numbers are also searchable so that a or healthcare provider can be contacted directly or traced if the or healthcare provider has moved. As more CISs are installed and standardization occurs, more extensive searching will become available. It is anticipated that all patient records at multiple locations, including APSs, PBMs, and unrelated records will be searchable from one location with one request.

The widespread use of the present invention may additionally facilitate a standardized communication conduit for all healthcare providers, creating a more interactive healthcare practice. Healthcare facilities and providers, clinics, hospitals, pharmacies, laboratories and medical information repositories can share and exchange information to improve the quality and efficiency of healthcare services. Such information can be electronically transmitted and received to and from a healthcare facility or a healthcare provider's electronic portable or hand held device.

Using the present invention, lab results, prescriptions, diagnosis, treatments, and coverage information could all be made available electronically in a standardized format and transmitted securely to authorized parties or stored in a secure database. The present invention makes possible standardized electronic and online practice protocol, greatly enhancing such practices. Using the information made available by the present invention, electronic and online prescriptions, for example, are safer, more accurate and more economical, as doctors, pharmacies and benefit managers have access to needed information

While one embodiment illustrates a facilitator at a location remote from the requestor, this invention also anticipates the searching software being located directly on requester computers or being accessible thereby.

The present invention further contemplates the use of “deidentifying” methods and processes for allowing information from the present invention to be distributed for use in medical research. De-identified information comprises information that is void of any identifying information as described and taught herein, and as understood by one ordinarily skilled in the art.

### BRIEF DESCRIPTION OF THE DRAWINGS

FIG. 1 illustrates a flowchart of a presently preferred embodiment in accordance with the present invention utilizing a remote facilitator/nonrmalizer;

FIG. 2 illustrates a flowchart of another embodiment of the present invention utilizing direct communication between the CIS provider and the requestor for returning patient record repeats;

FIG. 3 illustrates a flowchart of another embodiment utilizing a direct connection between the CIS and the requestor for both requests and return information;

FIG. 4 illustrates a flowchart of another embodiment showing direct connection between the requestor and the medical record source;

FIG. 5 illustrates a flowchart of an embodiment in which software is loaded at both the requestor and destination sites to accomplish transmittal of requests and responses;

FIG. 6 illustrates a flowchart of an embodiment in which facilitating software is loaded at the facilitator's server, the vendor's server and the healthcare facility's server; and

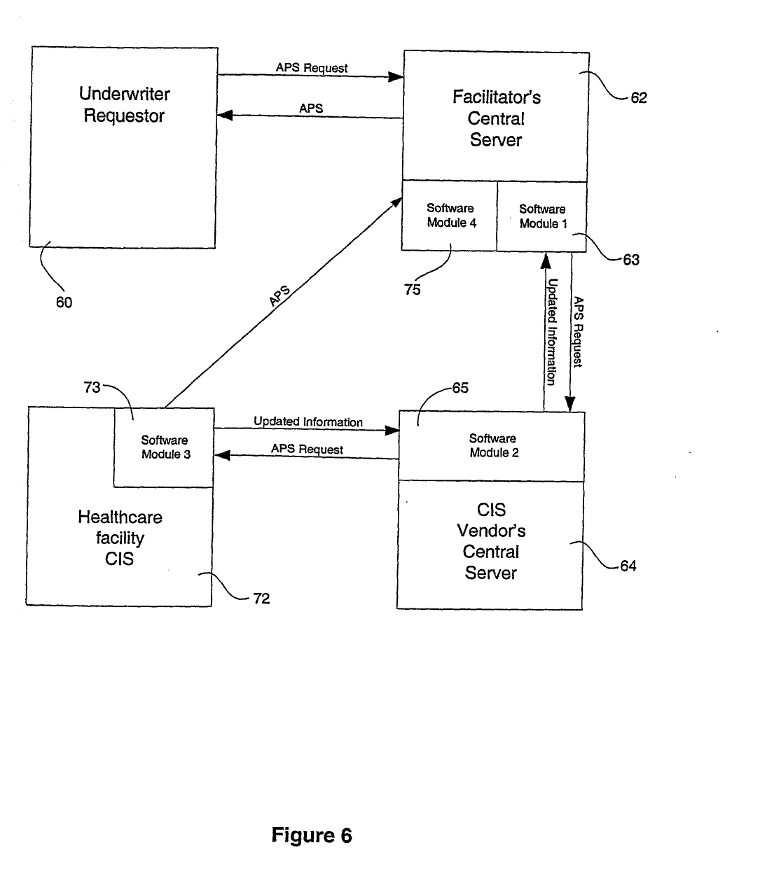

FIG. 7 illustrates a flowchart of an embodiment in which facilitating software is loaded at the facilitator's server and the vendor's server.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

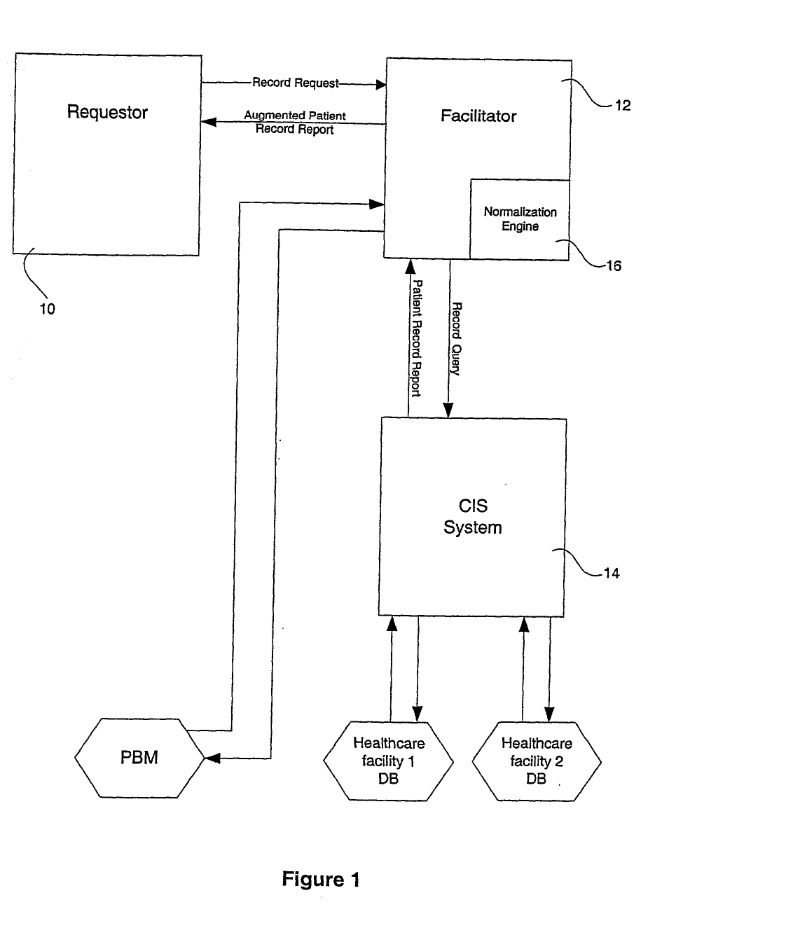

FIG. 1 illustrates a flowchart of a preferred embodiment, in accordance with the present invention. A requestor 10 can be an insurance company, a physician with a new patient, or any other individual or institution which desires to have medical information regarding an individual or a group of individuals. Requestor 10 places a record request with a facilitator 12. Facilitator 12 verifies that there is a patient record waiver included with the request, determines the best sources for the requested information, and formulates a record query. The record query includes the patient waiver if the records are requested from a source which requires the waiver. It will be appreciated that the facilitator may determine that some information is available from non-confidential sources or sources which have a lower level of confidentiality not requiring a patient waiver. In the method illustrated in FIG. 1, the facilitator has determined that the record query should be sent to a computer information system (CIS) 14. In an effort to provide increased searchability and to reduce the amount of effort required to search patient records, as well as a desire to increase the inclusivity of information regarding a particular patient, many healthcare providers in healthcare facilities have retained the services of a computer information system expert to electronically manage computerized patient records. The services may be provided by the vendor of the facility's CIS or some other computer information system manager. For purposes of this application the terms “CIS manager” and “CIS vendor” may be used interchangeably. A CIS manager may transfer information from paper records over to a digital format which allows for searching. Because storage of this information may require expensive servers and additional space, and to increase the ease of maintenance, these records may be stored at a CIS which is remote from the healthcare facility or physician's office. Some CISs are maintained on site with imbedded central server software allowing access to the data by the CISs manager. When the record query reaches CIS 14 a search is made of the records stored on the server, and the patient records are located. Included in the patient information is the name and DEA number of the physician and the physician's location. The physician is then contacted by the CIS manager indicating that a record query has been placed and requesting the physician's authorization to forward the patient record to the requestor. A copy of the patient's records may also be forwarded. After the physician has reviewed the record query and accompanying patient records, a physician authorizes the release of those records and the records are forwarded from the CIS 14 back to the facilitator 12.

It will be appreciated that the amount of time required by the physician and his staff in approving release of records is greatly reduced because no search time is expended by the physician nor his or her staff since the records are provided directly by the CIS to the physician. The physician can quickly review the records and provide electronic authorization to release the records.

In addition to the cost effectiveness of the system, the CIS is also more reliable in providing all of the appropriate records. Because no physical records are handled, the files are not misplaced nor any of their contents lost. This results in a better and more thorough review by the physician of the records, and a better report being sent back to facilitator 12.

When the patient record report is received by facilitator 12, the patient record report will be in the format provided by the CIS. Since these systems vary, the information may not be in a format readable by, or desired by, the requestor. The records can be transmitted in a standard machine readable format or, in one embodiment, facilitator 12 has on record the preferred format of requester 10 and may normalize the patient record report into the appropriate format if needed. The normalization of this information occurs in a normalization engine 16. After normalization, or if the information does not require normalization, the patient record report is forwarded from facilitator 12 to requestor 10. Because all of the process occurs electronically, the amount of time between the placing of the record request and the return of the patient record report is greatly reduced. If the physician authorizes the request for the information in a timely manner, the patient record report may be returned to the requester in the same day that the record request was made. If the physician preauthorizes the release of the information, the patient record report may be forwarded to the requestor 10 in minutes.

This is especially valuable when the patient record report leads the requester to understand that other sources of information will be required or that other sources of information are available. For example, if the patient record report indicates that the patient has a disease requiring medication, requester 10 can request pharmaceutical information from a pharmacy benefit manager (PBM) 18. Information regarding the progress of the disease can be derived from the pharmaceutical information to augment the patient record report forwarded by CIS 14. When several sources of information are combined in the augmented patient record report forwarded by facilitator 12, requestor 10 can make a more informed decision.

In addition to patient record reports, other information is also available using the method illustrated in FIG. 1. For example, a physician's DEA number should be associated with each report. If the requestor has additional questions, the appropriate physician can be located using this DEA number and can be contacted to request additional information. If the patent record report is discontinuous, facilitator 12 may prompt the CIS to determine if the physician has moved. If the physician has moved, facilitator 12 can prompt several CIS providers to determine the new location of the physician. The physician may then be contacted to determine if he or she still provides service to the patient. This is especially important when a patient's name or other information has changed such as through marriage, etc. It will be appreciated that while only one CIS is illustrated in FIG. 1, facilitator 12 is connected to many such CISs. In addition, facilitator 12 can be connected to many PBMs or other patient record sources. When used herein, “patient record” is defined to mean all traditional and nontraditional patient medical information including clinical information, APRs, PBMs, paper-based patient records which have been digitized, computer-based patient records offered through CISs, electronic medical records, personal health records, Internet records, etc. Facilitator 12 has access to many patient record sources. Upon receiving a record request, facilitator 12 queries all sources or a preselected number of sources and combines all that information in the augmented patient record report forwarded to the requestor.

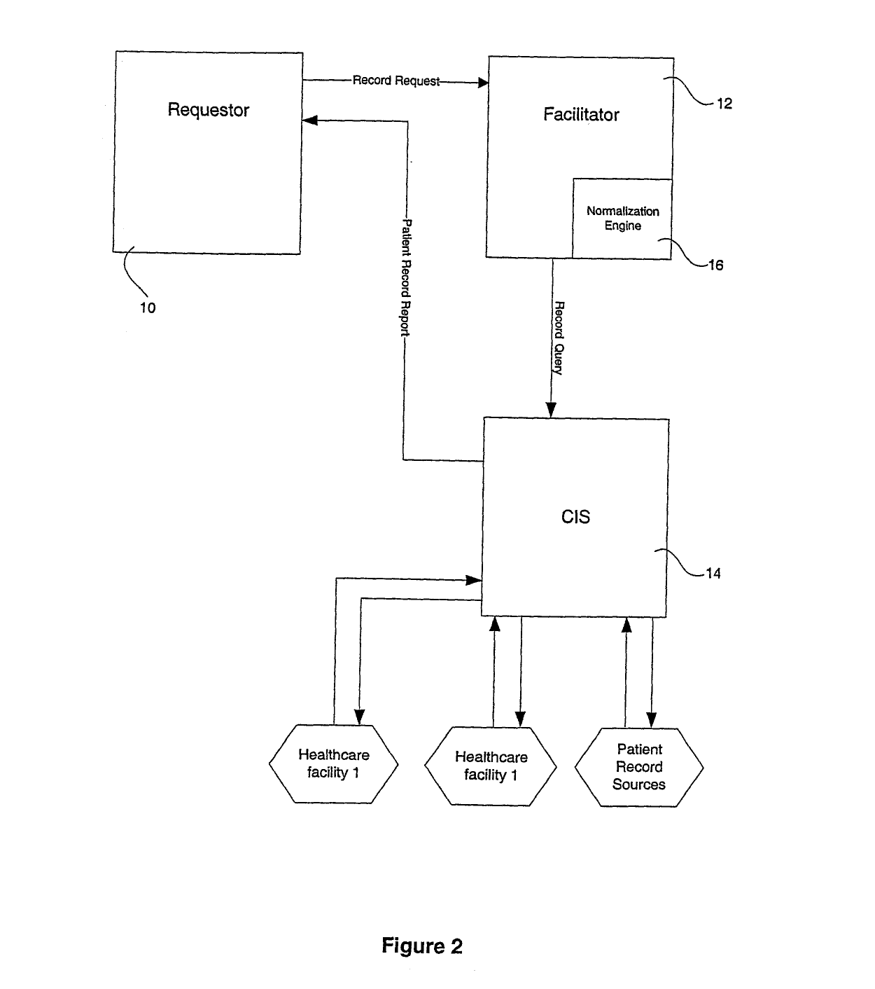

Turning now to FIG. 2, another embodiment of the present invention is illustrated in which the role of facilitator 12 is reduced. In this embodiment, requestor 10 makes a record request of facilitator 12. Facilitator 12 makes a record query of CIS 14. CIS 14 uses information such as the social security number, name, and address to determine whether the individual has records within any of the clients which the CIS serves. If patient records are available from this patient record source, then the CIS requests authorization from the appropriate physician to release the records. Upon authorization by the physician, the CIS forwards the records directly to requester 10. Although this embodiment does not provide the benefits of gathering information from multiple sources, or normalizing and augmenting the patient report, this embodiment is useful when only limited information is required and the CIS can provide the information in a format which is acceptable by the requester. Since the CIS is paid for the records forwarded to the requester, and the facilitator does not provide the service of normalization or augmentation, the CIS manager may charge more money for providing the records directly to the requester. In order to enjoy this benefit, however, the CIS must provide the information in a format which is acceptable or at least tolerable by the requestor.

As discussed above, many CIS managers are queried by the facilitator and in the embodiment illustrated in FIG. 2, more then one CIS could respond to the record query by the facilitator by forwarding a patient record report directly back to the requestor 10. Neither FIG. 2 nor any embodiments disclosed herein are intended to be restricted to only one facilitator or only one CIS manager. It is anticipated that many patient record sources and multiple facilitators may be utilized in each of these embodiments. Some of the benefits are achieved, however, by utilizing only one facilitator as the normalization and augmentation services provided by the facilitator are more beneficial when only one facilitator is utilized. Because not all patient record sources may allow access by all facilitators, however, there may be instances when several facilitators are required to gather a comprehensive patient record report.

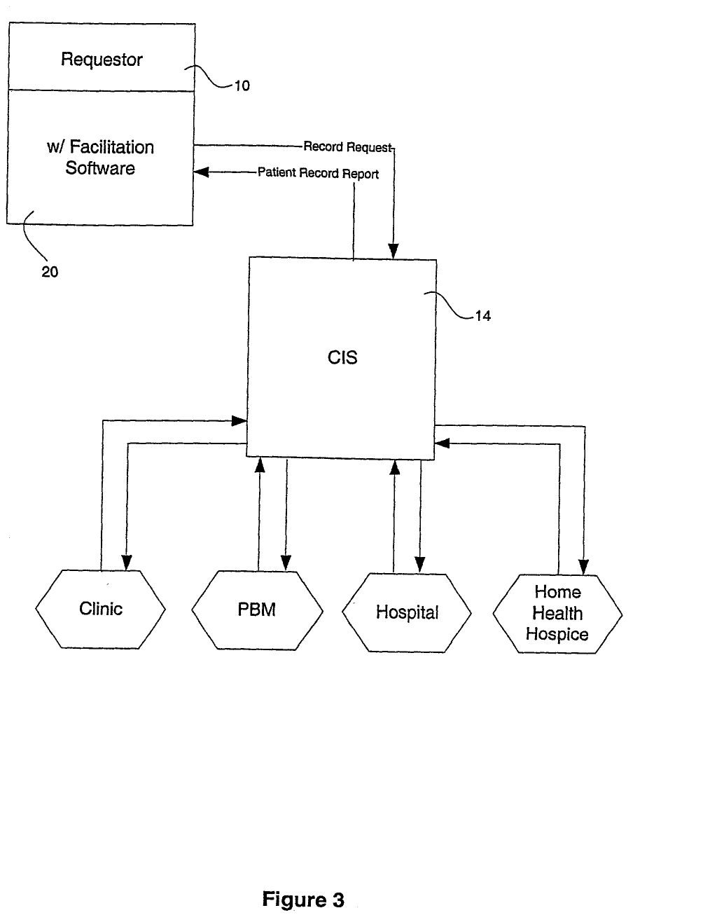

Referring now to FIG. 3, another embodiment of the present invention is depicted in which the function of the facilitator 12 and normalization engine 16 have been imported into the requestor's computer system. Requestor 10 now has facilitation software 20 available for directly querying patent record sources for records. In the embodiment illustrated in FIG. 3, a record query is forwarded to CIS 14 from facilitation software 20. CIS 14 then forwards the record query to all of the patient record sources that CIS 14 hosts. It will be appreciated that the functionality of CIS 14 is increased in the role it plays in the embodiment illustrated in FIG. 3. As can be seen in the illustration, CIS 14 manages records for not only healthcare facilities and individual physicians, but also hospitals, home care providers, hospices, pharmacies and other sources of patient records. As with the other embodiments, facilitation software 20 may contact many such CISs, however, because the CISs have assumed additional responsibilities, it is anticipated that fewer CISs will need to be contacted when utilizing the method of this embodiment. After receiving information from several of the patient record sources, CIS 14 forwards a patient record report back to facilitation software 20 which then normalizes and combines all of the information from the CIS into a single report viewable by the requestor.

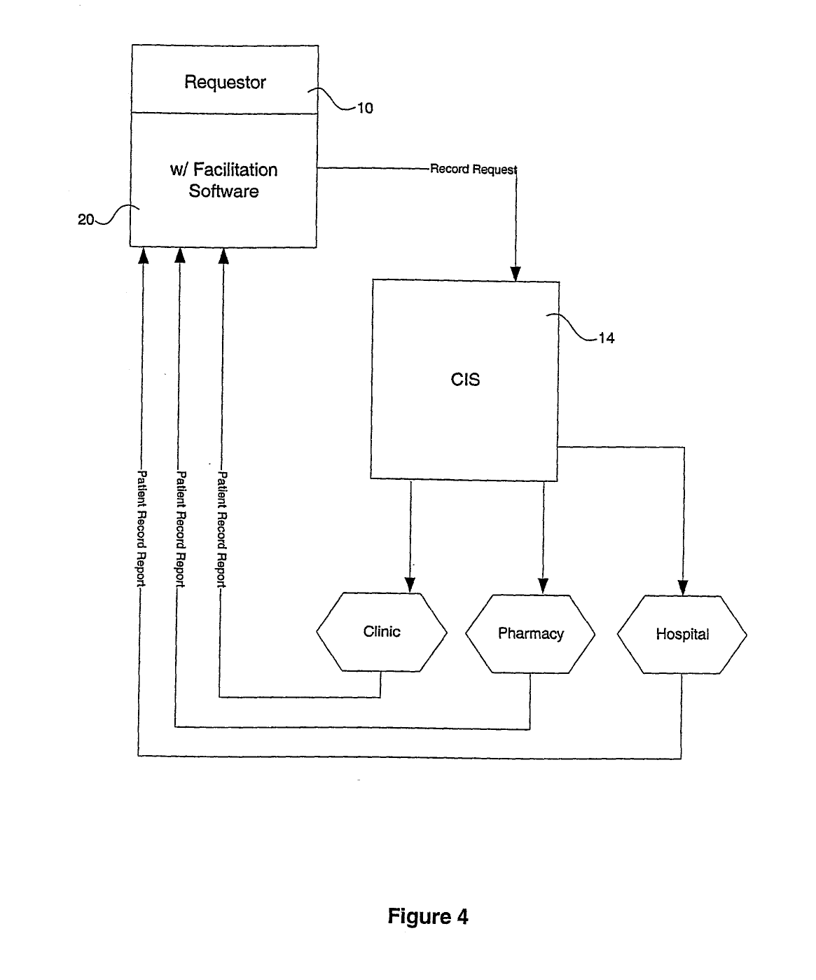

Turning now to the embodiment illustrated in FIG. 4, requestor 10 has available facilitation software 20 which can place a record request with a CIS 14. The embodiment depicted in FIG. 4 varies from that shown in FIG. 3, however, in that the patient record sources forward the records directly back to the facilitation software instead of passing through the CIS. Facilitation software 20 may then either forward the patient record reports from each of the patient record sources directly to the requester or may wait until all of the information is provided and then normalize and augment the report before forwarding it to the requestor. Alternatively, the software may wait a prescribed period of time before normalizing and augmenting a report for the requestor.

Although not depicted, it will be appreciated that the present invention anticipates a combination of the methods set forth in FIG. 3 and FIG. 4 in which some of the patient record sources provide the patient record report back to the CIS and other patient record sources forward the information directly to the facilitation software. The depiction used in this application are not meant to restrict the scope of the claims, but instead serve to facilitate in the discussion of the present invention.

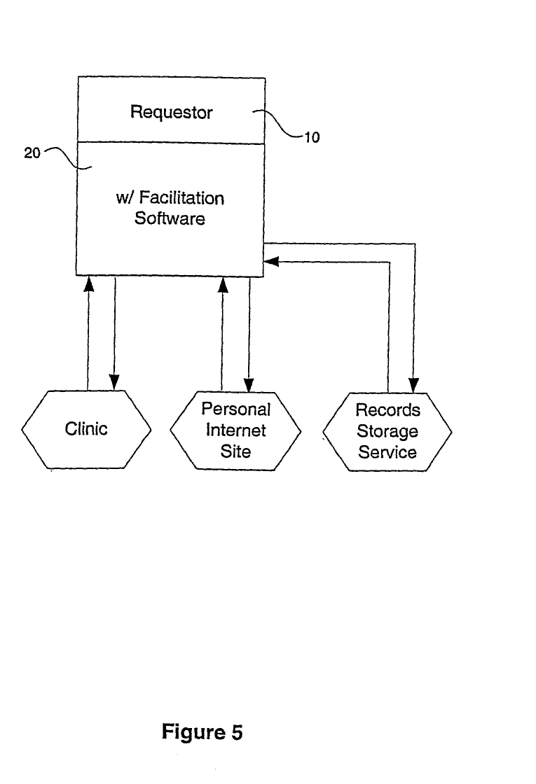

Turning now to FIG. 5, an embodiment of the present invention is depicted in which requestor 10 has available facilitation software 20 which places record queries directly to patient record sources. Facilitation software 20 may then normalize and augment the patient record reports from the sources as the information is received or until a preset time limit has elapsed before prompting the requestor.

It will be appreciated that the requestor may also monitor the status of information received the facilitation software that any time even though a report has not been generated. If a requester views an incomplete report, information may be nevertheless gleaned from that report which prompts the requestor to request information from other patient record sources. This is especially beneficial if incomplete information is had regarding the name, address, or social security number of the patient. Using the embodiment in FIG. 5, a requestor having only a limited amount of information regarding the patient, for example, only the sex, first and last name, could place a record request through the facilitation software and receive patient record reports which could be then culled through to locate the correct patient. A more extensive record query can then be launched to locate more confidential and secure patient record sources to receive a complete patient record report.

Although the facilitator 12 and facilitation software 20 as well as CIS 14 all have access to multiple patient record sources, not all of those patient record sources need be contacted upon the receipt of each record query or record request. To save time and costs, a requester 10 may provide a limited request to the facilitator 12 and may be satisfied with the results received from that limited query. If not satisfied, the requestor may then request additional information from other perhaps more expensive sources from facilitator 12.

### Program Storage Device

It will be apparent to those of ordinary skill having the benefit of this disclosure that any of the foregoing variations may be implemented by programming one or more suitable general-purpose computers having appropriate hardware. The programming may be accomplished through the use of a program storage device readable by the computer and encoding a program of instructions executable by the computer for performing the operations described above. The program storage device may take the form of, e.g., one or more floppy disks; a CD ROM or other optical disk; a magnetic tape; a read-only memory chip (ROM); and other forms of the kind well-known in the art or subsequently developed. The program of instructions may be “object code,” i.e., in binary form that is executable more-or-less directly by the computer; in “source code” that requires compilation or interpretation before execution; or in some intermediate form such as partially compiled code. The precise forms of the program storage device and of the encoding of instructions are immaterial here.

### EXAMPLE 1

In one example of one embodiment of the present invention, a system for retrieving computer-based patient records via computer network allows an insurance underwriter 60 to request computer-based patient records from a computerized patient records (CPR) facilitator. The system comprises a facilitator's central server 62 connected to the a computer network. The facilitator's server is capable of receiving information and requests from insurance underwriters, vendors of computer information systems, and healthcare facilities using a computer network such as the Internet. The facilitator's server is also capable of sending information and requests to the insurance underwriters, vendors of computer information systems for CPRs, and healthcare facilities over the Internet. The facilitator's central server is secure and is not used to retain any information from a CPR. The facilitator server merely makes it possible to electronically request and deliver the CPR to the underwriter.

The facilitator's server networks to a plurality of CIS vendors servers 64. The CIS vendors (CIS-Vs) are the vendors that install and maintain the computer information systems for CPRs used at physicians healthcare facilities. In this embodiment of the present invention, the facilitator installs a secure, requesting software module 63 onto the facilitator's server. The secure software module (M1) on the facilitator's server is then networked to a second facilitator software module (M2) 65 installed on each of the CIS—V central servers.

As will be explained more fully below, the facilitator is able to determine which vendor should receive the underwriter's request based on information provided by the underwriter and information provided by the various vendors. The appropriate vendor's server receives the underwriter's request via the facilitator.

Each of the CIS vendors is networked to the CISs 72 in the healthcare facilities which the vendor services. Typically, a vendor has a direct network connection to the CISs in the healthcare facilities it services in order to provide maintenance and customer service to the healthcare facility's CISs. Through the network connection, the vendor is able to transmit the requests and information from the M2 module to a third software module (M3) 73 installed on the healthcare facility CIS for that purpose. The M3 module on the healthcare facility's CIS is connected to the network in a way that allows the M3 to send information to the facilitator's server and subsequently to be delivered to the underwriter.

In an alternative embodiment, the CPR from the healthcare facility is sent from the M3 module on the healthcare facility CIS to a fourth software module (M4) 75 on the facilitator's server. The M4 receives the report and may augment the information being transmitted. For example, the M4 may normalize the information to a convenient format for transmission or reception or may remove or add information from the CPR as necessary or desired.

In this example the underwriter desires to know medical information about an insurance applicant. Using a keyboard and visual interface, such as personal computer, the underwriter logs onto the facilitator's server over the Internet and orders an APS associated with the applicant. As the request is being processed, the underwriter's personal computer receives and displays the current status/progress of APS retrieval.

The facilitator's central servers (FCS) receive the request from the underwriter for retrieval of an individual's medical record (APS). The FCS receives status information from M1 and transmits it to the underwriter's personal computer for immediate viewing by the underwriter. The central server delegates the underwriters request to M1, operational within the facilitator's central servers, to determine if an electronic medical record (e-APS) is likely to exist. Typically the request contains information sufficient to determine which healthcare facility generated the APS. For example the request may include information regarding a physician's demographics, including the DEA number, as well as the detailed information about the healthcare facility where that physician now practices, or has previously practiced. This information from the request, together with information obtained from the vendors, facilitates retrieving the medical record.

The M1 module analyzes the request to determine if the healthcare facility is using a CIS system and therefore knows whether to attempt retrieval of an electronic medical record (e-APS). If it appears that no e-APS exists, M1 sends negative acknowledgment to the underwriter about the e-APS and may offer to initiate an order for physical-or manual-retrieval of the paper-based APS. If a healthcare facility is using a vendor's CIS, the M1 determines which vendor system is installed at the facility. If it appears that an e-APS might exist on a CIS, M1 sends an affirmative acknowledgment to the underwriter indicating that the e-APS retrieval process has commenced. The M1 continues to post further status indicators showing key procedures in the retrieval process as they occur.

M1 determines which CIS vendor has this e-APS, and also indicates in which healthcare facility it is stored. M1, running on FCS, initiates the sequence to forward the request for the e-APS to the external module, M2, which is running on the specified CIS vendor's central server. M1 then initiates transmission of the request for the e-APS to M2. Upon receipt of the request for the e-APS from M1, M2 responds by acknowledging receipt of the request, and then continues sending current status information about progress in the handling of the request back to M1.

In addition to receiving information through M2 about the specific request, M1 may receive new and updated information on the various healthcare facilities and healthcare providers who are using that vendor's computer information system. M2 sends all update information on existing-as well as any additional or new-healthcare facilities which have installed their CIS to M1. M2 also routinely transmits to M1 any and all information about any changes about any of their existing or newly-registered healthcare providers at any of their installed sites, including when they commenced/terminated practicing at their healthcare facilities.

M1 receives the update information on healthcare facilities and healthcare providers from the M2, and then files and indexes such data. M1 also maintains the files containing all demographics and related information about each healthcare facility, as well as each healthcare provider who is using or who has ever used that vendor's system. Maintaining all of the indices to these files on M1 provides very powerful search capabilities relating to any healthcare facility and for any healthcare provider who is using or who has ever used a CIS system.

Similarly, M1 also receives all transaction information concerning the processing of e-APS requests from the M2 and then files, archives, and indexes such data. M1 maintains the files containing all accounting and related information about each transaction associated with each vendor's information system and with each of their installed systems. M1 may continually or periodically receive notice and the updated processing status from M2.

When M2 receives the request for retrieval of an electronic medical record (e-APS), from M1, the request for the e-APS contains information such as the DEA number of the healthcare provider and the vendor's internal ID of the specific healthcare facility where the healthcare provider practices, to facilitate locating the record. M2 sends notice of receipt of request to M1 and continues to transmit updates to M1 concerning processing status.

Having identified the specific healthcare facility at which the record is likely to be kept, M2 sends the request for a specific e-APS to M3, which is running on the installed CIS at the designated healthcare facility. M2 receives the notice and the processing status from M3 and continues sending status info to M1.

M3 receives request from M2 at the CIS vendor's server for retrieval of an electronic medical record (e-APS). In this example, the request contains DEA number of the healthcare provider, and the internal ID of the specific healthcare facility where the healthcare provider practices or practiced, that is, the healthcare facility where it is anticipated that the e-APS resides. M3 then sends to M2 the notice of receipt of request for the e-APS and updates the processing status.

Each of the vendor's installed CIS systems maintains a record of all demographics for all healthcare providers who utilize their system to document patient encounters, and M3 receives and tracks the identity of each healthcare provider user, including their DEA number and the internal ID of the specified healthcare facility(s) where each healthcare provider practices. M3 then sends to M2 the complete information about each healthcare provider user registered at the healthcare facility where the CIS is installed. This provides M2 the information it needs to quickly locate the healthcare facility where the electronic record is likely to reside.

Like M1, M2 receives all new and updated information on healthcare facilities and healthcare providers from the M3, located in installed CIS systems from each particular vendor, and then M2 files and indexes all such data. M2 maintains the files containing all demographics and related information about each healthcare facility and each healthcare provider who is using, or who has ever used, one of the deployed systems from this particular CIS vendor. Maintaining of the indices to these files allows M2 to provide very powerful search capabilities relating to any healthcare facility and for any healthcare provider who is using, or who has ever used, a deployed system from this CIS vendor.

M2 receives all transaction information concerning the processing of e-APS requests from the M3 and files, archives, and indexes such data. M2 maintains the files containing all accounting and related information about each transaction associated with a particular CIS vendor and M2 with each of their installed systems. Along with the requests from M2 for retrieval of one the e-APS), M3 receives a digitized copy of the signed authorizations for release of each patient's computer-based patient record. M3 sends to M2 the notice of receipt of request and authorization for the e-APS and updates the processing status.

M3 submits a notification such as a page, e-mail, phone message, etc. to the healthcare facility's systems administrator (SA) at the site, indicating one or more of the following: 1) a request for one or more specified CPRs/EMRs has been received from their vendor's server; 2) the request(s) is awaiting the SA's timely response; and 3) the more rapidly the SA clicks on to “release” the record, the more money the practice will receive for this electronic retrieval.

Transparently, but using M3, the healthcare facility's systems administrator (SA) at the site reviews each request for a medical record. The SA may examine the signed authorization for release of the patient's record and, after verifying all aspects of the transaction, the SA can send the encrypted medical record securely over the Internet to the facilitator's central server. In one alternative embodiment, the record is transmitted to a fourth module, located on the FCS where the record may be normalized or augmented in some way.

M3 monitors the timing of the healthcare facility's systems administrator's (SA) action/inaction in response to the request. If the SA does not take action within the specified and agreed-upon time frame (driven by parameters within M3), automated escalation procedures are invoked to ensure timely release of the desired patient record(s). With M3 embedded and installed at each of CIS vendor's customer's sites, the M3 maintains a record of all aspects of each transaction, including all data required by HIPAA.

In one embodiment, M3 interacts with the CIS system by sending the request and receiving the medical record in a machine readable formats such as an Excel spreadsheet; a MS Word document or a standard Crystal Reports format. M3 then sends to M2 the transaction information (only the “envelope”) about each patient record that was transferred by M3 to M4. The actual patient record is not transmitted to M2, the record is encrypted and securely transmitted to the facilitator's central server.

M3 receives new and updated information on healthcare facilities and the practicing healthcare providers from the vendor's system-that is, from the deployed CIS system installed at this particular healthcare facility. M3 maintains the files containing all demographics and related information about each healthcare facility and about each healthcare provider who is using, or who has ever used, this particular CIS system installed at this particular healthcare facility. M3 maintains all of the indices to these files to provide very powerful search capabilities relating to any healthcare facility and for any healthcare provider who is using, or who has ever used, this installed system from this CIS vendor.

M3 also maintains the files containing all accounting and related information about each transaction associated with the particular installed CIS system from the vendor. M3 maintains the files containing all demographics and related information about each healthcare facility and transmits it to the M-2 installed on the CIS vendor's central system. Furthermore, M3 maintains all of the HIPPA information about each transaction required by the regulations.

M3 sends to the FCS (or M4 on the FCS) the fully populated transaction, including the “envelope” or accounting information and all clinical information about each patient record which was requested by the facilitator. Within the FCS, the M3 installed in each of CIS vendor's customer's site can communicate with the facilitator's central server via the Internet. Alternatively, the M3 can communicate with the FCS via a dial-up to an 800 number operated by the facilitator. The FCS then receives the filly populated transaction from M3 and securely transmits it to the authorized underwriter. Authorization for all of the release of the records is conducted preferably using digital certificates, however, other form authorization, such as biometric authorization, may be employed.

FCS retains only the “envelope” information about each transaction. No actual patient record data is retained by the facilitator. The facilitator only acts as conduit to allow the information to flow more easily from the healthcare facility to the authorized requestor.

### EXAMPLE 2

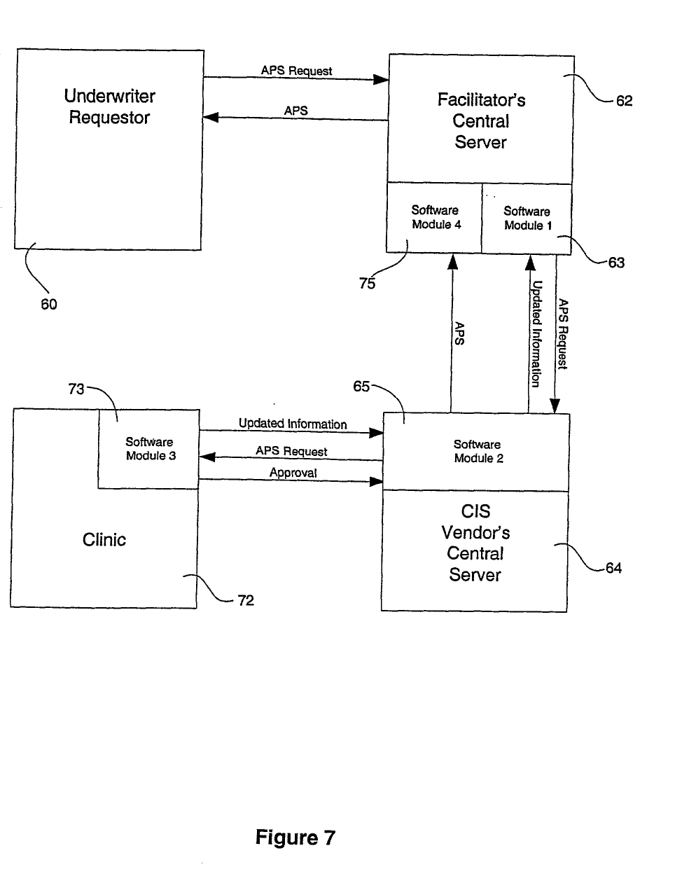

In a second embodiment of the present invention, shown in FIG. 7, a system for retrieving computer-based patient records via computer network allows an insurance underwriter 60 to request computer-based patient records from a CPR facilitator. The system comprises a facilitator's central server 62 connected to the a computer network. The facilitator's server is capable of receiving information and requests from insurance underwriters, vendors of computer information systems for CPRs, and healthcare facilities using a computer network such as the Internet. The facilitator's server is also capable of sending information and requests to the insurance underwriters, vendors of computer information systems for CPRs, and healthcare facilities over the Internet. The facilitator's central server is secure and is not used to retain any information from a CPR. The facilitator server merely makes it possible to electronically request and deliver the CPR to the underwriter.

The facilitator's server networks to servers 64 of a plurality of computer information system vendors. (CIS—V). The CIS—Vs are the vendors that install and maintain the computer information system for CPRs used at healthcare facilities. In this embodiment of the present invention, the facilitator installs a secure, requesting software module onto the facilitator's server. The secure software module (M1) 63 on the facilitator's server is then networked to a second facilitator software module (M2) 65 installed on each of the CIS—V central servers.

As will be explained more fully below, the facilitator is able to determine which vendor should receive the underwriter's request based on information provided by the underwriter and information provided by the various vendors. The appropriate vendor's server receives the underwriter's request via the facilitator.

Each of the CIS vendors is networked to the CISs 72 in the healthcare facilities which the vendor services. Typically, a vendor has a direct network connection to the CISs in the healthcare facilities it services in order to provide maintenance and customer service to the healthcare facility's CISs. Through the network connection, the vendor is able to transmit the requests and information from the M2 module to a third software module (M3) 73 installed on the healthcare facility CIS for that purpose. The M3 module on the healthcare facility's CIS is connected to the network in a way that allows the M3 to send information to the facilitator's server. In this example the CPR's are maintained on the CIS vendor's servers rather than the healthcare facility's CIS. The vendor communicates with the healthcare facility in order to receive the necessary authorization to release the CPR's to the requestor.

The CPR is sent from the vendor to a fourth software module (M4) 75 on the facilitator's server for securely receiving and transmitting it to the requestor the CPR. Additionally, the M4 may augment the information being transmitted. For example, the M4 may normalize the information to a convenient format for transmission or reception or may remove or add information from the CPR as necessary or desired.

In this example the underwriter desires to know medical information about an insurance applicant. Using a keyboard and visual interface, such as personal computer, the underwriter logs onto the facilitator's server over the Internet and orders an APS associated with the applicant. As the request is being processed, the underwriter's personal computer receives and displays the current status/progress of APS retrieval.

The facilitator's central servers (FCS) receive the request from the underwriter for retrieval of an individual's medical record (APS). The FCS receives status information from M1 and transmits it to the underwriter's personal computer for immediate viewing by the underwriter. The central server delegates the underwriters request to M1, operational within the facilitator's central servers, to determine if an electronic medical record (e-APS) is likely to exist. Typically the request contains information sufficient to determine which healthcare facility generated the APS. For example the request may include information regarding the physician's demographics, including the DEA number, as well as the detailed information about the healthcare facility where that physician now practices, or has previously practiced. This information from the request, together with information obtained from the vendors, facilitates retrieving the medical record.

The M1 module analyzes the request to determine if the healthcare facility or healthcare facility is using a CIS for CPRs and therefore knows whether to attempt retrieval of an electronic version of the attending physician statement (e-APS) or other similar electronic medical records. If it appears that no e-APS exists, M1 sends negative acknowledgment to the underwriter about the e-APS and may offer to initiate an order for physical-or manual-retrieval of the paper-based APS. If a healthcare facility which vendor's system is installed there at this particular healthcare facility is using a CIS, the M1 determines which vendor system is installed at the facility. If it appears that an e-APS might exist on a CIS, M1 sends an affirmative acknowledgment to the underwriter indicating that the e-APS retrieval process has commenced. The M1 continues to post further status indicators showing key procedures in the retrieval process as they occur.

M1 determines which CIS vendor has this e-APS, and also indicates which healthcare facility can grant release of the record. M1, running on FCS, initiates the sequence to forward the request for the e-APS to the external module, M2, which is running on the specified CIS vendor's central server. M1 then initiates transmission of the request for the e-APS to M2. Upon receipt of the request for the e-APS from M1, M2 responds by acknowledging receipt of the request, and then continues sending current status information about progress in the handling of the request back to M1.

In addition to receiving information through M2 about the specific request, M1 may receive new and updated information on the various healthcare facilities and healthcare providers who are using that vendor's computer information system. M2 sends all update information on existing-as well as any additional or new-healthcare facilities which have installed their CIS to M1. M2 also routinely transmits to M1 any and all information about any changes about any of their existing or newly-registered healthcare providers at any of their installed sites, including when they commenced/terminated practicing at their healthcare facilities.

M1 receives the update information on healthcare facilities and healthcare providers from the M2, and then files and indexes such data. M1 also maintains the files containing all demographics and related information about each healthcare facility, as well as each healthcare provider who is using or who has ever used that vendor's system. Maintaining all of the indices to these files on M1 provides very powerful search capabilities relating to any healthcare facility and for any healthcare provider who is using or who has ever used a CIS for CPRs.

Similarly, M1 also receives all transaction information concerning the processing of e-APS requests from the M2 and then files, archives, and indexes such data. M1 maintains the files containing all accounting and related information about each transaction associated with each vendor's information system and with each of their installed systems. M1 may continually or periodically receive notice and the updated processing status from M2.

When M2 receives the request for retrieval of an e-APS from M1, the request for the e-APS contains information such as the DEA number of the healthcare provider and the vendor's internal ID of the specific healthcare facility where the healthcare provider practices, to facilitate locating the record. The vendor may keep all of the medical records from the faicilities it services in one large central database from which the record can be extracted and delivered to the requester. However, the records from each facility the vendor services are likely to be kept in discrete databases, so as not to be co-mingled with the records of any other healthcare facility. M2 sends notice of receipt of request to M1 and continues to transmit updates to M1 concerning processing status.

Having identified the specific healthcare facility where the record was generated and thereby located the specific database in which the record is likely to be kept, M2 sends the request for the release of the specific e-APS to M3 at the designated healthcare facility. M2 receives the notice and the processing status from M3 and continues sending status info to M1.

M3 receives request from M2 at the CIS vendor's server for release of an electronic medical record (e-APS). In this example, the request contains DEA number of the healthcare provider, and the internal ID of the specific healthcare facility where the healthcare provider practices or practiced, that is, the healthcare facility where it is anticipated that the e-APS was generated. M3 then sends to M2 the notice of receipt of request for the e-APS and updates the processing status.

Each of the vendor's installed CIS maintains a record of all demographics for all healthcare providers who utilize their system to document patient encounters, and M3 receives and tracks the identity of each healthcare provider user, including their DEA number and the internal ID of the specified healthcare facility(s) where each healthcare provider practices. M3 then sends to M2 the complete information about each healthcare provider user registered at the healthcare facility where the CIS is installed. In one embodiment, M3 transfers the e-APS and other relevant data from the CIS through M3 and to M2 where the information is used to populate and update the database. In addition to providing the APS information itself, this information flow provides M2 the information it needs to quickly locate the healthcare facility where release authorization can be obtained. M3 interacts with the healtcare facility's system by sending electronic medical records and information in a machine readable formats such as an Excel spreadsheet; a MS Word document or a standard Crystal Reports format to M2. The electronic patient record is transmitted to M2 and stored on the CIS vendor's database. Naturally, the record is encrypted and securely transmitted to the vendor's server.

Like M1, M2 receives all new and updated information on patient records, healthcare facilities and healthcare providers from the M3, located in installed CIS from each particular vendor, and then M2 files and indexes all such data. M2 maintains the files containing all demographics and related information about each healthcare facility and each healthcare provider who is using, or who has ever used, one of the deployed systems from this particular CIS vendor. Maintaining of the indices to these files allows M2 to provide very powerful search capabilities relating to any healthcare facility and for any healthcare provider who is using, or who has ever used, a deployed system from this CIS vendor.

M2 receives all transaction information concerning the processing of e-APS requests from the M3 and files, archives, and indexes such data. M2 maintains the files containing all accounting and related information about each transaction associated with a particular CIS vendor and M2 with each of their installed systems. Along with the requests from M2 for release of one the e-APS), M3 receives a digitized copy of the signed authorizations for release of each patient's computer-based patient record. M3 sends to M2 the notice of receipt of request and authorization for the e-APS and updates the processing status.

M3 submits a notification such as a page, e-mail, phone message, etc. to the healthcare facility's systems administrator (SA) at the site, indicating one or more of the following: 1) a request for one or more specified CPRs has been received from their vendor's server; 2) the request(s) is awaiting the SA's timely response; and 3) the more rapidly the SA clicks on to “release” the record, the more money the practice will receive for this electronic retrieval.

Transparently, but using M3, the healthcare facility's systems administrator (SA) at the site reviews each request for a medical record. The SA may examine the signed authorization for release of the patient's record and, after verifying all aspects of the transaction, the SA can send the release securely over the Internet to the facilitator's central server.

M3 monitors the timing of the healthcare facility's systems administrator's (SA) action/inaction in response to the request. If the SA does not take action within the specified and agreed-upon time frame (driven by parameters within M3), automated escalation procedures are invoked to ensure timely release. With M3 embedded and installed at each of CIS vendor's customer's sites, the M3 maintains a record of all aspects of each transaction, including all data required by HIPAA.

M3 receives new and updated information on healthcare facilities and the practicing healthcare providers from the vendor's system-that is, from the deployed CIS system installed at this particular healthcare facility. M3 maintains the files containing all demographics and related information about each healthcare facility and about each healthcare provider who is using, or who has ever used, this particular CIS system installed at this particular healthcare facility. M3 maintains all of the indices to these files to provide very powerful search capabilities relating to any healthcare facility and for any healthcare provider who is using, or who has ever used, this installed system from this CIS vendor.

M3 also maintains the files containing all accounting and related information about each transaction associated with the particular installed CIS system from the vendor. M3 maintains the files containing all demographics and related information about each healthcare facility and transmits it to the M-2 installed on the CIS vendor's central system. Furthermore, M3 maintains all of the HIPPA information about each transaction required by the regulations.

M2 sends to the FCS (or M4 on the FCS) the fully populated transaction, including the “envelope” or accounting information and all clinical information about each patient record which was requested by the facilitator. The M2 installed in the vendor's servers can communicate with the facilitator's central server via the Internet. Alternatively, the M2 can communicate with the FCS via a dial-up to an 800 number operated by the facilitator. The FCS then receives the fully populated transaction from M2 and securely transmits it to the authorized underwriter. Authorization for all of the release of the records is conducted preferably using digital certificates, however, other form authorization, such as biometric authorization, may be employed.

FCS retains only the “envelope” information about each transaction. No actual patient record data is retained by the facilitator. The facilitator only acts as conduit to allow the information to flow more easily from the healthcare facility to the authorized requestor.

The value of the present system is not limited to its ability to efficiently obtain medical information for individuals. The system is also valuable in that it provides the possibility of gathering medical information relevant to groups of individuals or large populations. For example, the medical information that is retrievable using the present invention could also be valuable in medical research. Medical information made available by the present system for groups of individuals or large populations could improve the efficiency and quality of medical research.

Research and development of pharmaceuticals is one area of medical research for which the present invention could provide significant advantages. One of the most difficult tasks in conducting medical research for pharmaceuticals is finding human subjects that have a medical history profile appropriate for testing an experimental drug. Often researchers are left to purchasing advertising in print and broadcast media in order to solicit public participation in drug studies. These advertisements may be limited in their ability to convey to the listener the specific requirements for participating in the test and are limited in many other ways by the form of the media employed. In addition to advertising, researchers may solicit specific medical practitioners or clinics with a reputation for specializing in an area of medicine related to the pharmaceutical being tested. After consulting with practitioners, the researchers may be able to recruit patients of the practitioner that match the profile necessary for the pharmaceutical testing. Further screening may be necessary even after individuals are identified or have volunteered for participation in the study to determine if they suffer from conditions or are undergoing treatments that could compromise the results of the study.

Using the system of the present invention, populations of human subjects for pharmaceutical studies could be more readily identified by querying medical information contained in the medical information repository. With this information, researchers could identify the general geographic locations of large numbers of people who have an appropriate medical profile for the study. Similarly, the non-specific information obtained from the database could direct the search for human subjects to clinics and physicians that have patients with the appropriate medical profile. Researchers could approach clinics where information indicates they have patients that could participate in a particular study and request the assistance of physicians in evaluating or soliciting the participation of one or more of their patients. Using a medical information repository, researchers who use public advertisements to solicit participation could better target their advertising to populations where individuals are more likely to fit the profile.

The use of the medical information repository to solicit participants in a pharmaceutical study can expedite the approval process of the drug by shortening the time it takes to conduct trials, by providing better subjects that in turn result in a more reliable study, thereby improving the clinical testing portion of the approval process. Shortening the approval process provides an economic advantage to a pharmaceutical company. If the company developing the pharmaceutical is going to have proprietary rights in the drug, those proprietary rights will have a limited life span. In the United States, for example, the term of a patent for a research pharmaceutical is approximately 20 years from the date of filing of the patent application. However, the entire research and development process can take 14 or 15 years and cost hundreds of millions of dollars. The company's right to recoup this investment through the exclusive manufacture and sale of the drug will last only through the life of the patent, after which the drug will be available for generic reproduction from others who have not invested in its research and development. During the period of time in which a pharmaceutical company has exclusive rights to produce a new drug after it has been approved for use, the drug company can profit from the exclusive manufacture and distribution of the drug. With blockbuster drugs, the daily net profit can be very high. Thus, by expediting the approval process even a few days through the use of medical information repository to more efficiently locate individual interested in participating in clinical trials and studies, the present system can provide many millions of dollars of benefit to the pharmaceutical company prior to the termination of its exclusive manufacturing rights.

In the present legal climate, distribution of medical information is highly regulated. For example, in the United States privacy rules have been established to prevent the release of personal medical information without authorization. These rules apply to information that makes it possible to identify an individual based on the information. The most obvious forms of “individually identifiable” information would be a person's name or social security number. But other less obvious types of information could be used to “identify” someone, such as their date of birth, address, and occupation. The federal regulations require the consent of the person whose medical information is to be released or distributed, if it is possible to individually identify the person based on the information.

Before information from a medical information repository could be released to a research company hoping to identify individuals or groups of people or populations to solicit for pharmaceutical studies, the individuals would have to give consent or the medical information would have to be altered such that no person can be individually identified from the health information. “De-identifying” information requires more than simply removing names or addresses of patients, since in some circumstances, a combination of medical and related non-medical information could be used to individually identify a person whose information is being distributed. In order to legally distribute such information, a medical information repository would have to remove all “identifying” information including: identifiers of the individual or of relatives, employers, or household of members of the individual associated with the record, which identifiers include names, geographic subdivisions, elements of dates related to any individual, telephone numbers, fax numbers, e-mail addresses, Social Security numbers, medical record numbers, health plan beneficiary numbers, account numbers, certificate license numbers, vehicle identifiers and serial numbers, including license plate numbers, device identifiers and serial numbers, URLs, IP addresses, biometric identifiers, photographic images, any other unique identifying number, characteristic or code. Where removing such information is not practical or renders the data useless, the medical information repository may instead release medical information upon condition that a person with appropriate knowledge and experience with generally accepted statistical and scientific principles has applied a “deidentifying” methodology to remove or make certain that no personally identifiable information is released from the repository.

The present invention contemplates the use of “deidentifying” methods and processes for allowing information from the present invention to be distributed for use in medical research. Furthermore, the benefits of the release of this information extends beyond pharmaceutical research to other areas, such as marketing and public health. The information distributed by the present invention can be deidentified at one of any number of points, including being deidentified at the originating source of the information, such as the PBM, or the clinic from which the medical information is being collected. It may also be deidentified in a process entirely separate from the originating source of the information, but in any case, the information must be deidentified prior to being released or distributed. Thus, the present invention assists a user in finding both personalized information of an individual for which there is authorization to obtain such information and provides the deidentified medical information that can be obtained without consent.

In one embodiment of the present invention, a research company desires to conduct clinical studies of a drug for treating pediatric patients with type II diabetes. In order to efficiently locate potential subjects, the research company queries a medical information repository associated with pharmaceutical benefit management groups. The medical information repository is able to search the database for any individuals under the age of 18 who are taking the drug glucophage, a drug commonly used to treat type II diabetics. In order to comply with privacy rules, the medical information repository does not release the identity of these individuals or the specifics of their medical records, but rather compiles a list of the physicians who wrote the prescriptions for glucophage. The list of these physicians is then provided to the research company, where such a list does not pose any risk of individually identifying a physician's patient. The physicians can then be contacted regarding this study and asked if they have patients they believe would be interested in participating. In this way, the process of locating potential participants in the study is expedited. Likewise, the database could be used to monitor compliance with drug regimens to determine if patients are willing to follow through with the taking of certain medication, based on subsequent prescription requests. Public health officials can access the database in order to track illnesses by evaluating the reports of physicians or prescriptions written by them.

The particular embodiments disclosed above are illustrative only, as the invention may be modified and practiced in different but equivalent manners apparent to those skilled in the art having the benefit of the teachings herein. Furthermore, no limitations are intended to the details of preferred environments or preferred embodiments herein shown, other than as described in the claims below. It is therefore evident that the particular embodiments may be altered or modified and all such variations are considered within the scope and spirit of the invention. Accordingly, the protection sought herein is as set forth in the claims below.

What is claimed:

1. A method of searching for medical information executed by one or more computers comprising the steps of:
a) formulating a record request for patient medical information;
b) forwarding the record request to a facilitator, wherein the facilitator reviews the record request and determines which patient record sources to contact;
c) contacting at least one patient record source with a record query electronically requesting information regarding a patient;
d) initiating an electronic search of medical records within the patient record source;
e) de-identifying the medical records retrieved from the patient record source; and
f) returning a patient record report containing information held by the patient record source, wherein the patient record report and the information returned therein is void of any identifying information.

2. A method as set forth in claim 1, wherein the information from the patient record source is not released before a physician gives approval.

3. A method as set forth in claim 1, wherein the information from the patient record source is released automatically.

4. A method as set forth in claim 1, wherein the facilitator receives the patient record report in a machine readable format augments the report before forwarding it to the requester.

5. A method as set forth in claim 1, wherein the facilitator receives the patient record report and normalizes and augments the report before forwarding it to the requester.

6. A method as set forth in claim 1, wherein the patient record source is a CIS.

7. A method as set forth in claim 1, wherein the patient record source is an EMR system

8. A method as set forth in claim 5, wherein the search is conducted using software modules installed in a central server, CIS vendor server and a CIS.

9. A method as set forth in claim 7, wherein if the search determines that the information is available at one of its sources, the information is forwarded in a patient record report to the requestor.

10. A method as set forth in claim 1, wherein the facilitator receives a patient record report and normalizes that report into a format acceptable to the requestor.

11. A method as set forth in claim 9, wherein the facilitator receives patient record reports from several patient record sources and combines those reports into an augmented patient record report which is forwarded to the requestor.

12. The method as set forth in claim 1, wherein the step of de-identifying comprises applying a de-identifying methodology to remove and make certain no personally identifiable information is released.

13. A method of searching for medical information executed by one or more computers, the method comprising the steps of:
a) formulating a record query requesting information regarding an individual;
b) forwarding the record query to a patient record source;
c) receiving a patient record report from the patient record source, said patient record report being de-identified to remove identifying information.

14. A method as set forth in claim 13, wherein the patient record source is a computerized patient record manager.

15. A method as set forth in claim 14, wherein the computerized patient record manager has contact with other patient record sources and queries those patient record sources before responding to the record query with a patient record report.

16. A method as set forth in claim 13, wherein the step of forwarding the record query and the step of receiving a patient record are carried out using secure and encrypted means for communication.

17. A method for providing medical information executed by at least one computer, the method comprising the steps of:
a) receiving a record query requesting information regarding an individual;
b) searching a registry of databases to locate the available records;
c) obtaining the records;
d) de-identifying the records; and
e) forwarding the records to the requester.

18. A method as set forth in claim 17, wherein the step of receiving a record query comes from a voice telephone call supplemented by a form of authorization and verification.

19. A method for determining a location of a patient record created by a healthcare giver at a healthcare facility comprising the steps of:
a) establishing computer network connectivity between a request facilitator central server and a plurality of healthcare facilities' databases, said plurality of databases being populated by information identifying the healthcare givers using the healthcare facility database and dates for which the healthcare giver was associated with the healthcare facilities' databases to the request facilitator;
b) transmitting the identifying information from the plurality of healthcare facilities' databases to the request facilitator's central server including information indicating from which health care facility database the identifying information originates;
c) creating a searchable index of the identifying information;
d) submitting a request for the patient record to the request facilitator, the request including information identifying the healthcare giver and an approximate date of creation of the patient record;
e) querying the searchable index based on the request to determine the location of the patient record; and
f) identifying the location of the patient record.

20. The method of claim 19 wherein at least one of the plurality of healthcare facilities' databases is operated by a healthcare facility.

21. The method of claim 19 wherein at least one of the plurality of healthcare facilities' databases is operated by a CIS vendor.

22. The method of claim 19 wherein the identifying information includes the healthcare giver's DEA number.

23. The method of claim 19 wherein the computer network connectivity is established over the Internet.

24. The method of claim 19 comprising the additional step of releasing and transmitting the patient record from the location to the request facilitator.

25. The method of claim 24, wherein the patient record is de-identified prior to it being transmitted.

26. The method of claim 19 comprising the additional step of releasing and transmitting the patient record from the location to a requestor making the request.

27. The method of claim 26, wherein the patient record is de-identified prior to it being transmitted.

28. The method of claim 24 wherein the step of releasing and transmitting the patient record is specifically authorized by an appropriate healthcare giver.

29. The method of claim 24 wherein the step of releasing and transmitting the patient record is by an appropriate healthcare giver is monitored for timeliness.

30. The method of claim 24 wherein the step of releasing and transmitting the patient record is automatically authorized by an appropriate healthcare giver.

31. The method of claim 19 wherein the location of the patient record is one of a plurality of computer information systems separate from the healthcare facilities' databases.

32. The method of claim 31 further comprising the step of additionally establishing computer network connectivity between the plurality of healthcare facilities' databases and the plurality of computer information systems.

33. The method of claim 32 wherein the healthcare facilities' databases are populated by identifying information transmitted from the plurality of computer systems where the patient records are located.
